(19) United States
(12) Patent Application Publication
(10) Pub. No.: US 2015/0016086 A1
(43) Pub. Date: Jan. 15, 2015

(54) Electric Candles With Luminescent Material

(71) Applicant: CANDELLA LLC, Orange, CA (US)

(72) Inventor: Douglas Patton, Irvine, CA (US)

(21) Appl. No.: 14/331,093

(22) Filed: Jul. 14, 2014

Related U.S. Application Data
(60) Provisional application No. 61/845,733, filed on Jul. 12, 2013.

(51) Int. Cl. F21S 10/04; F21V 9/08

(52) U.S. Cl. CPC F21S 10/04; F21S 10/046; F21V 9/08
USPC 362/84

(57) ABSTRACT

Electric lighting devices are described that include one or more luminescent materials configured to help create a flickering flame effect. The luminescent material(s) could be disposed within, under, or on an outer surface of the device's body or as part of the flame element extending from the body.

This application claims priority to U.S. provisional application having Ser. No. 61/845,733 filed on Jul. 12, 2013. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is electric lights and candles.

### BACKGROUND

The following description includes information that may be useful in understanding the present invention. It is not an admission that any of the information provided herein is prior art or relevant to the presently claimed invention, or that any publication specifically or implicitly referenced is prior art.

Various electric lights are known in the art. See, e.g., U.S. Pat. No. 8,132,936 to Patton et al., U.S. Pat. No. 8,070,319 to Schnuckle et al., U.S. Pat. No. 7,837,355 to Schnuckle et al., U.S. Pat. No. 7,261,455 to Schnuckle et al., U.S. Pat. No. 7,159,994 to Schnuckle et al., US 2011/0127914 to Patton et al., U.S. Pat. No. 7,350,720 to Jaworski et al.; US 2005/0285538 to Jaworski et al. (publ. December 2005); U.S. Pat. No. 7,481,571 to Bistritzky et al.; US 2008/0031784 to Bistritzky et al. (publ. February 2008); US 2006/0125420 to Boone et al. (publ. June 2006); US 2007/0127249 to Medley et al. (publ. June 2007); US 2008/0150453 to Medley et al. (publ. June 2008); US 2005/0169666 to Porchia, et al. (publ. August 2005); U.S. Pat. No. 7,503,668 to Porchia, et al.; U.S. Pat. No. 7,824,627 to Michaels, et al.; US 2006/0039835 to Nottingham et al. (publ. February 2006); US 2008/0038156 to Jaramillo (publ. February 2008); US 2008/0130266 to DeWitt et al. (publ. June 2008); US 2012/0024837 to Thompson (publ. February 2012); US 2011/0134628 to Pestl et al. (publ. June 2011); US 2011/0027124 to Albee et al. (publ February 2011); US 2012/0020052 to McCavit et al. (publ. January 2012); and US 2012/0093491 to Browder et al. (publ. April 2012).

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for improved candles and other light sources.

### SUMMARY OF THE INVENTION

The inventive subject matter provides apparatus, systems and methods for various embodiments of electric candles or other lighting devices having a luminescent material. In preferred embodiments, the candles include a flame element extending from a body of the device. The flame element can be at least partially illuminated by a primary light source, preferably disposed within the device's body. The flame element could be movable or stationary with respect to the body or housing of the device. Where movable, the flame element is preferably disposed at an upper portion of a pendulum that is mounted within the device's body such that the flame element can move when subjected to a magnetic force, air, or other propulsion means configured to disturb the pendulum from a resting position.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIGS. 1-2 are perspective views of various embodiments of devices having a luminescent material.

FIG. 3 is a front view of a schematic of a flame element having a luminescent material.

FIGS. 4-6 are front view of schematics of pendulums with flame elements having one or more luminescent materials.

FIGS. 7A-7B are front and side views of a schematic of a flame element comprising a luminescent material disposed between layers of the flame element.

FIG. 8 illustrates a bottom view of one embodiment of a device having a luminescent material at a bottom surface of the device.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The use of one or more luminescent material(s) in the housing or flame element of the electric lighting device has many unique and beneficial aspects when applied to faux flame candles. First, when a LED or other light source is focused on the moving or stationary flame element, the luminescent material can not only add glowing effects while the light source is illuminated, but also when the light source is off. It is contemplated that this effect can last for more than 20 hours after the light source is off. Second, the luminescent material(s) can also be applied to other elements of the candle body, such as the outer surface of the housing that may comprise wax, or interior parts of the device to create the desired glow effect through the other outside parts. Third, design elements such as a picture or pattern can be incorporated into the candle housing that illuminate when light is applied, and can stay illuminated even after the light source is turned off. See, e.g., FIG. 9. Fourth, the luminescent material(s) can be blended to have different colors on the top portion of the flame element than the bottom portion to create a more realistic multi-color flame effect. Fifth, the luminescent material(s) have many production application properties such as silk-screening, painting, labels and injection-molded glow (luminescent) material. These processes can be singular or potentially combined with other currently utilized on luminescent materials to create specific glow effects. In addition the flame element could be layered and/or laminated with different luminescent materials that have a variety of colors and/or translucencies. Finally, the bottom of the device can retain light from the light source, which advantageously can illuminate the controls at the bottom of the device and allow a user to control the device in low-light or no-light conditions.

Contemplated luminescent materials can come in a variety of forms, including, for example, powder such as Europium UltraGlow®, paint, printing inks, material for injection molding, stickers, glazes, thread or other fibers, and so forth. The specific material(s) can be selected based on suitability for manufacture and desired color. Luminescent materials come in a variety of colors including red, green, yellow, orange, blue, purple, and more.

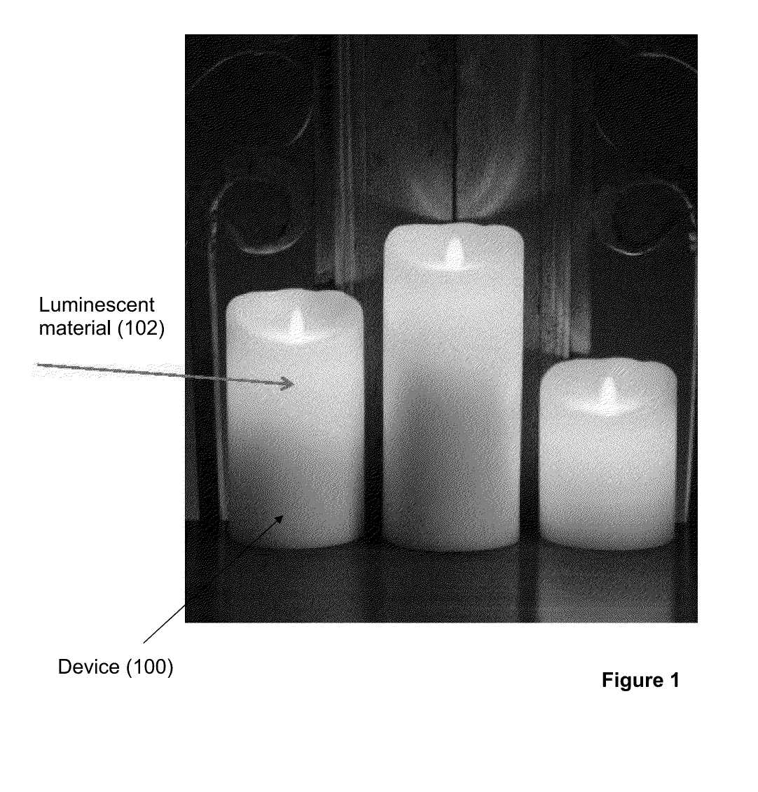

As shown in FIG. 1, luminescent material(s) can be molded into the wax outer surface 102 of the device 100, painted on the surface, or be in the injection molded sleeve that supports the candle wax during manufacturing.

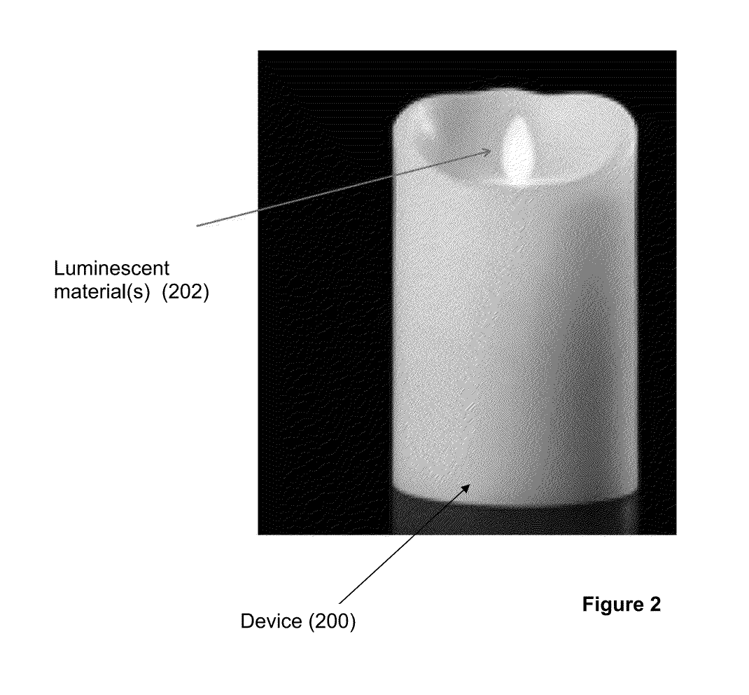

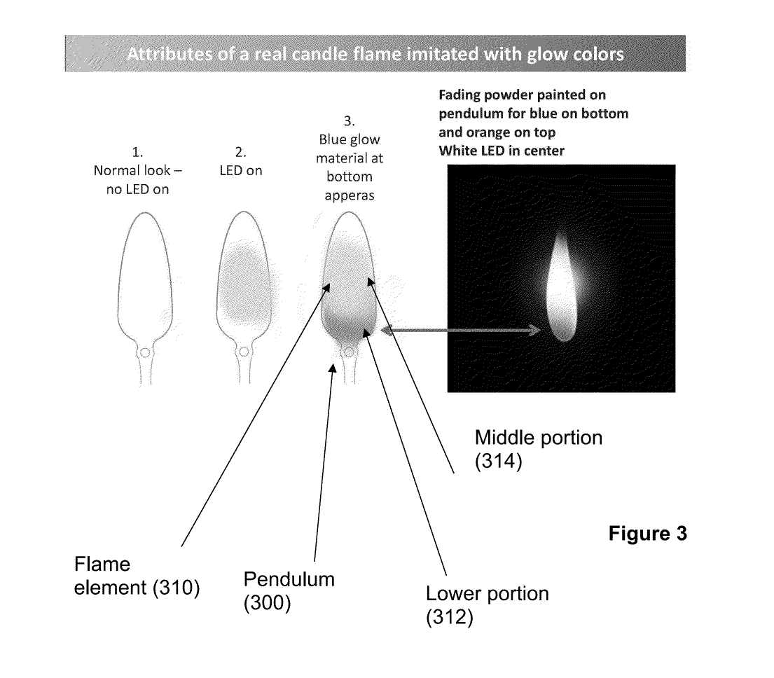

Alternatively or additionally, as shown in FIG. 2, luminescent material(s) 202 can be incorporated into the flame element 204 itself of the electric lighting device 200. In some contemplated embodiments, the specific luminescent material(s) can be chosen to help simulate the glow of a real flame having an orange upper portion, a brighter white or yellow middle portion and a blue, lower portion. FIG. 3 illustrates one embodiment of a pendulum 300 for an electric lighting device having a flame element 310 having luminescent material that creates a blue color glow at a lower portion 312 of the flame element 310. Light from a LED or other light source preferably within the device can be directed on a middle portion 314 of the flame element 310.

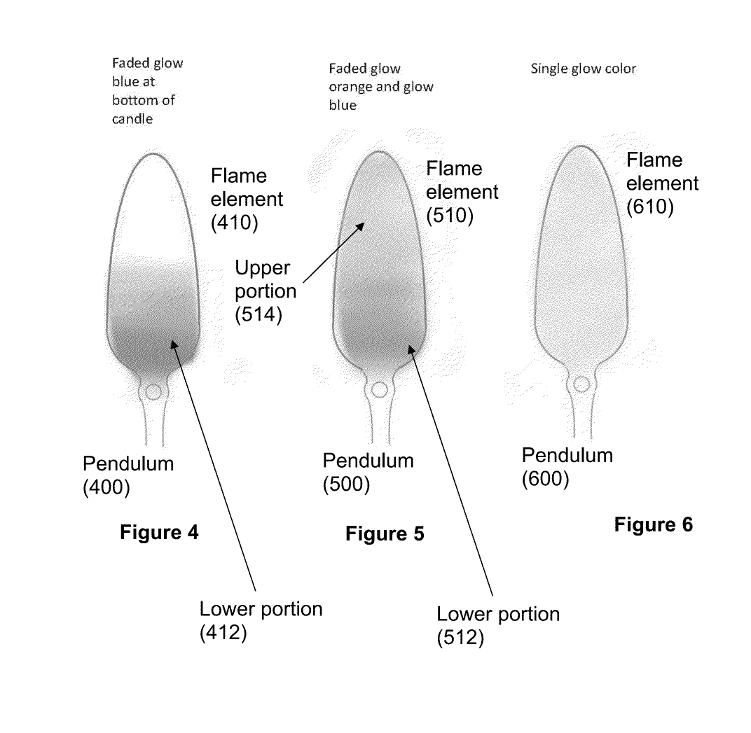

FIG. 4 illustrates another embodiment of a pendulum 400 having a flame element 410 having luminescent material that creates a faded glow of a blue color at a lower portion 412 of the flame element 410. FIG. 5 illustrates another embodiment of a pendulum 500 having a flame element 510 having luminescent material that creates a blue color glow at a lower portion 512 of the flame element 510 and an orange color at an upper portion 514 of the flame element. FIG. 6 illustrates another embodiment of a pendulum 600 having a flame element 610 having luminescent material that creates a single glow color across a surface of the flame element 610.

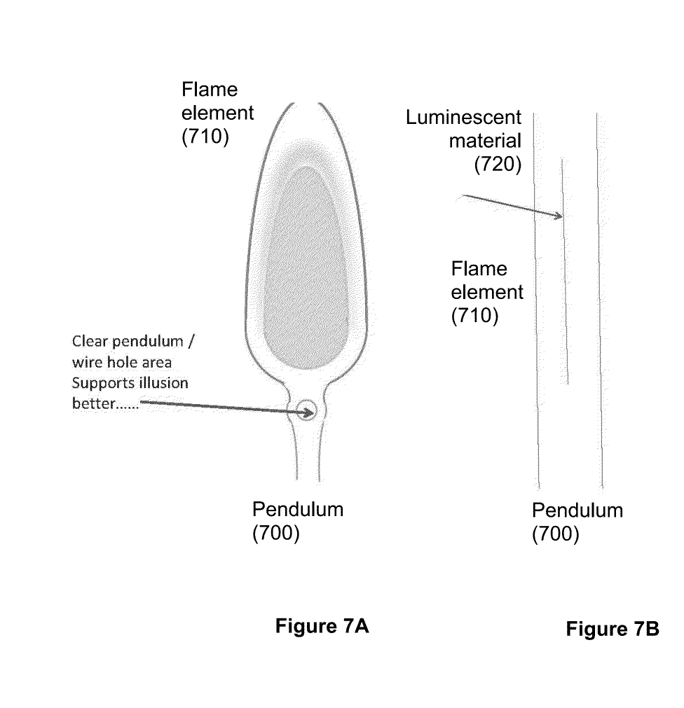

In still other contemplated embodiments, it is contemplated that the flame element 700 could comprise one or more layers that are laminated to form the flame element 700, for example. As shown in FIGS. 7A-7B, a pendulum 700 can include a flame element 710. The pendulum 700 and flame element 710 can be transparent or translucent with the flame element 710 comprising a layer of luminescent material 720 disposed within the flame element 710. In some embodiments, the flame element 710 could comprise three layers of plastic that collectively sandwich the luminescent material.

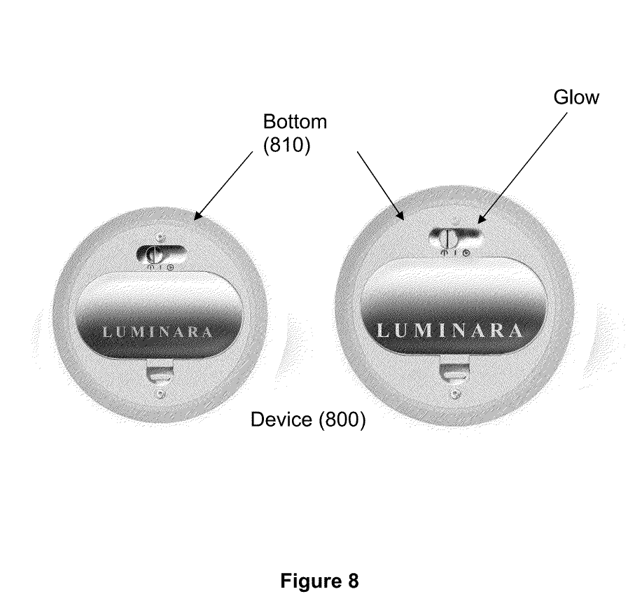

As shown in FIG. 8, the bottom 810 of the lighting device 800 can be translucent and absorb light from the light source disposed within the candle, despite not being visible while the device 800 is disposed in its normal, upright position. However, in this manner, the power switch and/or other controls of the candle can advantageously be illuminated, at least for a portion of time, even when the device 800 is off.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An electric lighting device, comprising:
a candle body;
a flame element coupled to, and extending from, an upper surface of the candle body;
a light source disposed with respect to the candle body such that light is emitted on the flame element; and
wherein at least a portion of the candle body or flame element comprises a luminescent material.

2. The device of claim 1, wherein the luminescent material comprises a powder.

3. The device of claim 1, wherein the luminescent material comprises a phosphorous material.

4. The device of claim 1, wherein at least a portion of the candle body comprises the luminescent material.

5. The device of claim 1, wherein at least a portion of the flame element comprises the luminescent material.

6. The device of claim 1, wherein the candle body further comprises an outer wax surface, and wherein the outer wax surface includes the luminescent material.

7. The device of claim 1, wherein the candle body further comprises an outer wax surface, and wherein the luminescent material is disposed beneath the outer wax surface.

8. The device of claim 1, wherein the candle body further comprises an outer wax surface, and wherein the luminescent material is embedded within the outer wax surface.

9. The device of claim 4, wherein the luminescent material is disposed with respect to the candle body such that an image is formed on the candle body when the luminescent material is exposed to light.

10. The device of claim 4, wherein the luminescent material is disposed on a bottom surface of the candle body, and wherein the bottom surface is opposite of the upper surface.

11. An electric lighting device, comprising:
a candle body;
a flame element coupled to, and extending from, an upper surface of the candle body;
a light source disposed with respect to the candle body such that light is emitted on the flame element; and
wherein at least a portion of the flame element comprises a luminescent material.

12. The device of claim 11, wherein a bottom portion of the flame element comprises the luminescent material, and wherein the luminescent material is configured to produce a blue color.

13. The device of claim 11, wherein the flame element comprises the luminescent material and a second luminescent material, and wherein the luminescent material is disposed below the second luminescent material on the flame element.

14. The device of claim 13, wherein the luminescent material is configured to produce a blue color and wherein the second luminescent material is configured to produce an orange color.

15. The device of claim 11, wherein the flame element comprises at least first and second layers, and wherein the luminescent material is disposed between the first and second layers.

16. An electric lighting device, comprising:
a candle body having upper and lower surfaces and a sidewall extending from the upper surface to the lower surface;
a flame element coupled to, and extending from, the upper surface;
a light source disposed with respect to the candle body such that light is emitted on the flame element; and
wherein at least a portion of the lower surface comprises a luminescent material.

17. The device of claim 16, wherein the lower surface comprises a power switch and wherein the luminescent material is configured to illuminate the power switch.

18. The device of claim 16, wherein the lower surface is disposed to contact a planar surface on to which the device is placed.

19. The device of claim 1, wherein the candle body defines an interior space, and wherein luminescent material is disposed within the interior space.

20. The device of claim 1, wherein the candle body is at least partially translucent.
